(19) United States
(12) Patent Application Publication
(10) Pub. No.: US 2025/0117508 A1
(43) Pub. Date: Apr. 10, 2025

(54) Methods of Controlling Access to and Presenting Text and Images in a Document File

(71) Applicant: Leonard L. Drey, St. Louis, MO (US)

(72) Inventor: Leonard L. Drey, St. Louis, MO (US)

(21) Appl. No.: 18/638,648

(22) Filed: Apr. 17, 2024

Related U.S. Application Data
(60) Provisional application No. 63/459,904, filed on Apr. 17, 2023.
(60) Provisional application No. 63/463,956, filed on May 4, 2023.
(60) Provisional application No. 63/470,300, filed on Jun. 1, 2023.
(60) Provisional application No. 63/525,797, filed on Jul. 10, 2023.
(60) Provisional application No. 63/536,053, filed on Aug. 31, 2023.
(60) Provisional application No. 63/623,864, filed on Jan. 23, 2024.

(51) Int. Cl. G06F 21/62

(52) U.S. Cl. CPC G06F 21/6218

(57) ABSTRACT

A content-access application and a registration code are provided to a user. The content-access application is opened and used to select a device. An identifier permanently associated with the device is determined and stored. The user provides the registration code and the identifier to the publisher. The publisher associates the registration code with the identifier to form a registration unit. To acquire content, the user requests a content file from and provides the registration code to the publisher, which associates the registration unit with the requested content file to form a unique user content file. The identifier of the registered device is compared with the associated identifier of the unique user content file. Access to the unique user content file is granted by the content-access application only on correspondence of the identifier associated with the unique user content file and the unique identifier stored by the registered device.

### CROSS-REFERENCE TO RELATED APPLICATIONS

This subject matter is related to the substance of the following patent applications, the entire disclosures of which are incorporated herein by this reference.
1. U.S. Provisional Application for Patent No. 63/545,537, filed on Oct. 24, 2023 (Leonard L. Drey, inventor), from which priority is claimed. [Title: “Methods of Presenting Text and Images”]
2. U.S. Provisional Application for Patent No. 63/525,797, filed on Jul. 10, 2023 (Leonard L. Drey, inventor), from which priority is claimed. [Title: “A Method of Selective Online Dissemination of Digital Assets”]
3. U.S. Provisional Application for Patent No. 63/470,300, filed on Jun. 1, 2023 (Leonard L. Drey, inventor), from which priority is claimed. [Title: “A Method of Selective Online Dissemination of Digital Assets”]
4. U.S. Provisional Application for Patent No. 63/463,956, filed on May 4, 2023 (Leonard L. Drey, inventor), from which priority is claimed. [Title: “Method of Selective Online Dissemination of Digital Assets”]
5. U.S. Provisional Application for Patent No. 63/459,904, filed on Apr. 17, 2023 (Leonard L. Drey, inventor), from which priority is claimed. [Title: “Method of Selective Online Dissemination of Digital Assets”]
6. U.S. Provisional Application for Patent No. 63/623,864, filed on Jan. 23, 2024 (Leonard L. Drey, inventor), from which priority is claimed. [Title: “Methods of Controlling Access to and Presenting Text and Images in a Document File”]
7. U.S. patent application Ser. No. 17/585,076, filed on Jan. 26, 2022 (Leonard L. Drey, inventor). [Title: “Method of Selective Online Dissemination of Digital Assets”]
8. U.S. patent application Ser. No. 17/585,066, Publication No. 2023/0115858-A1 (published Apr. 13, 2023) (Leonard L. Drey, inventor). [Title: “Method of Selective Online Dissemination of Digital Assets”]
9. U.S. patent application Ser. No. 17/373,432, Publication No. 2022/0058242-A1 (published Feb. 24, 2022) (Leonard L. Drey, inventor). [Title: “System and Method of Governing Content Presentation of Multi-Page Electronic Documents”]
10. U.S. patent application Ser. No. 17/170,580, Publication No. 2022/0027486-A1 (published Jan. 27, 2022) (Leonard L. Drey, inventor). [Title: “System and Method of Controlling Access to a Document File”]
11. U.S. patent application Ser. No. 15/600,501, Publication No. 2017/0337354-A1 (published Nov. 23, 2017) (Leonard L. Drey, inventor). [Title: “Method of Governing Content Presentation and the Altering of Multi-Page Electronic Documents”]
12. U.S. patent application Ser. No. 14/524,694, Publication No. 2016/0267065-A1 (published Sep. 15, 2016) (Leonard L. Drey, inventor). [Title: “Method of Governing Content Presentation of Multi-Page Electronic Documents”]
13. U.S. patent application Ser. No. 14/965,855, Publication No. 2016/0140530-A1 (published May 19, 2016) (Leonard L. Drey, inventor). [Title: “Method of Governing Content Presentation and the Altering of Multi-Page Electronic Documents”]
14. U.S. patent application Ser. No. 12/965,421, Publication No. 2011/0313899-A1 (published Dec. 22, 2011) (Leonard L. Drey, inventor). [Title: “Method of Governing Content Presentation”]
15. U.S. patent application Ser. No. 11/620,512, Publication No. 2007/0157086-A1 (published Jul. 5, 2007) (Leonard L. Drey, inventor). [Title: “Time-Controlled Presentation of Content to a Viewer”]

### FIELD OF THE INVENTION

In general, the invention relates to methods of presenting content such as text and images to a viewer, for example, on a viewing device such as a processor display or a dedicated e-reader. According to different aspects of the invention, access to the content can be controlled, and, once accessed, presentation of the accessed content can be controlled as well.

### BACKGROUND OF THE INVENTION

There are many ways in which electronic content can be presented to a viewer. Such content can include multi-media content, such as content that includes text and images. Typically, the content is fixed and static, excepting certain formatting to adapt the content to the particular device on which the reader accesses the content. Such static presentation, which mimics a hard-copy document, does not take advantage of the great potential for novel presentation that could be made available to a reader, which would enhance the viewing experience and which would provide flexibility allowing authors and publishers to provide enhanced content to the marketplace.

Further, digital files and associated content are easily accessible and disseminated unless access controls are applied to the files and/or the file storage and dissemination system. Controlling all aspects of access to the files is important to limiting the consumption of and maintaining the integrity of the content.

The following novel aspects of the invention address these and other issues, in order to enhance the security and flexibility of a digital book publishing system (presented by way of example), although the concepts presented herein can be applied to any system for disseminating digital files, and the present invention is not limited to any particular application.

### BRIEF SUMMARY OF THE INVENTION

The previous applications referenced above describe several features and aspects of a system for creating content files, for presenting those files to a user, and for accessing the files by a user. The files can be, for example, digital book files, or any other files having content, including multi-media content, that can be read or otherwise viewed by a user. The following disclosure presents additional features and enhancements to the system as previously described in the referenced applications.

A process of registering a device with a publisher includes providing, to a user, a content-access application. The content-access application is stored for access by a user computer processing device. The publisher provides a registration code to the user. The content-access application is opened on a computer processing device and a registration phase of the content-access application is initiated. The device, which has digital storage capability, is selected by the user through the content-access application. An identifier permanently associated with the selected device is determined by the content-access application; the identifier is a unique, unchangeable value that is characteristic of the selected device. The identifier is temporarily stored by the content-access application. The user provides the registration code and the identifier to the publisher through the content-access application. The publisher associates the registration code with the identifier to form a registration unit. The registration unit is stored by the publisher, thereby registering the selected device.

The device can be a digital storage device, or a computer processing device. The computer processing device can be the user computer processing device or another computer processing device. The digital storage device is operatively arranged as an internal component of another device, or operatively coupled to another device as an external component.

If the device is a computer processing device, the identifier can include a serial number, a container ID, a UDID, an IMEI, a MAC address, and/or a BIOS ID.

The selected device can be one of a plurality of available devices.

The registration code can be provided to the user by the publisher via email.

The registration code provided to the user by the publisher can be one of a plurality of registration codes.

The publisher can be one of a plurality of publishers with which the digital storage device can be registered.

The identifier associated with the selected device can be a first identifier, in which case the first identifier can be replaced with a second identifier associated with a second selected device, by the content-access application through a registration process with the publisher; the second identifier is a characteristic, unique, unchangeable value. The identifier replacement can occur when prompted by the user.

A process of acquiring digital content includes registering a device with a publisher as described above. The user requests a content file from the publisher. The user provides the registration code to the publisher. The publisher associates the registration unit with the requested content file, thereby forming a unique user content file. Therefore, the unique user content file can be provided to the user for presentation by the content-access application.

The unique user content file can be provided to the user electronically.

The process can also include storing the unique user content file to the registered device, by the user, and providing the unique user content to the content-access application, by the user.

The content file can be requested from the publisher by the user by accessing a publisher's website and selecting the content file at the website. The registration code can be provided to the publisher at the publisher's website.

The unique user content file can be provided to the user by providing the unique user content file stored on a new registered device.

A process of accessing digital content includes acquiring the content file as described above. The content-access application compares the identifier of the registered device with the associated identifier of the unique user content file. Access to the unique user content file is granted by and the unique user content file is opened in the content-access application only if the identifier associated with the unique user content file corresponds with the unique identifier stored by the registered device as compared by the content-access application.

The user can request access to the unique user content file stored on the registered device to the content-access application. Granting access to the unique user content file to the user by the content-access application can include granting different types of access, such as any combination of read access, write access, and/or print access. Access to different types of access, such as copy access, can be excluded or particularly denied.

Granting access to the unique user content file to the user by the content-access application can include granting offline access to the unique user content file. In the case of large files, or whenever beneficial or desired, downloaded content included in the unique user content file can be presented to the user even as the rest of the unique user content file is downloading. The unique user content file can include still images, animated images, sound files, and/or any combination of media types.

The process can also include enabling an encryption protocol between the publisher and the content-access application. In this case, the unique user content file can be encrypted before providing the unique user content file to the content-access application, and the encrypted unique user content file can be decrypted by the content-access application only after granting access to the unique user content file to the user by the content-access application.

### BRIEF SUMMARY OF THE DRAWINGS

FIG. 1 is a flow diagram showing an exemplary process of registering a device with a publisher according to the invention.

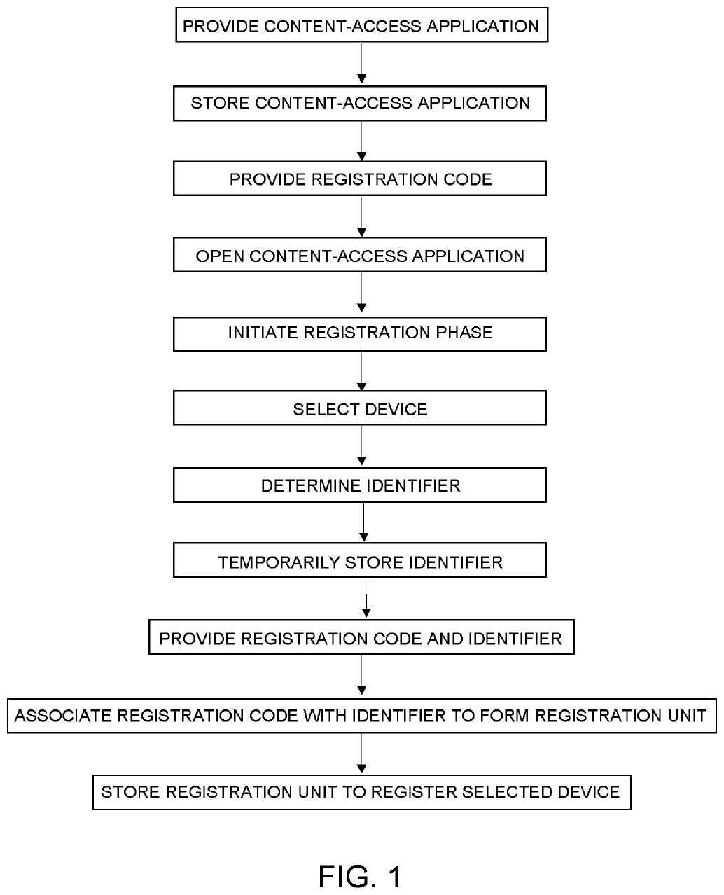

FIG. 2 is a flow diagram showing an exemplary process of acquiring digital content according to the invention.

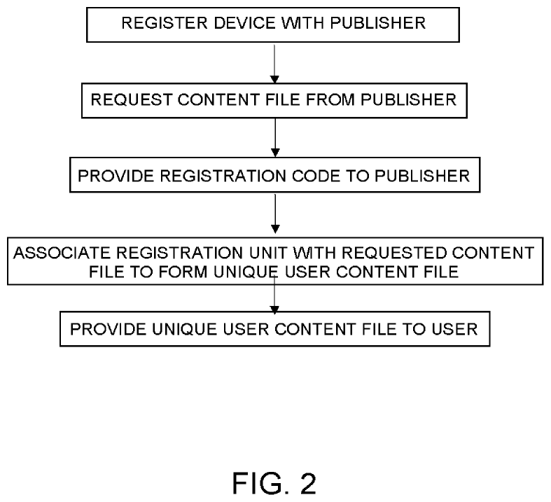

FIG. 3 is a flow diagram showing an exemplary process of accessing digital content according to the invention.

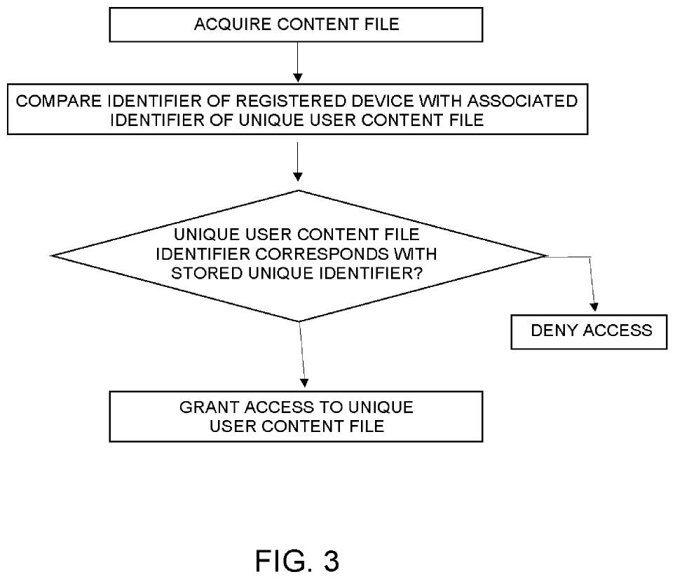

### DETAILED DESCRIPTION OF THE INVENTION

The invention includes an “app”—a processing application that is used to register a device and to acquire and access content by a user. The content is made available by a publisher to the user through the use of the application according to the process of the invention. The disclosed processes can stand alone, or can be performed in connection with other processes as required by the publisher, such as processes involving payment, for example as described in the related applications listed above. Likewise, the content and content file can be created and presented in any known fashion, for example conventionally or as described in the related applications listed above.

Transferring and accessing the content to and by a user requires registration of a target device on which the file will be stored and from which the file will be loaded and accessed. To register the device, the user needs the content-access application, which is provided to the user by a publisher. The content-access application allows for communication and file transfer between the user and the publisher and can be of the type that can be used on any processing platform, such as a desktop computer, laptop computer, tablet, or smart telephone, and is not restricted to any particular platform or operating system. The content-access application can be provided to the user by any known method, such as by download from an online app store, direct email, download from a publisher website, or on a physical storage medium. The publisher can provide the content-access application to the user directly, or through one or more third-party providers. Alternatively, the content-access application can be provided remotely for online access and use by the user.

The user stores the provided content-access application such that it can be accessed by a user computer processing device. For example, it can be stored on the user computer processing device, on an internal drive. Alternatively, it can be stored on a portable drive that can be accessed by the user computer processing device, or even in remote storage having online access. The computer processing device can be, for example, a desktop computer, laptop computer, tablet, or smart telephone running any operating system.

The publisher also provides a registration code to the user, again in any known manner (such as email), but preferably separately from provision of the content-access application, and preferably using a different communication channel or mode. This registration code is particular to the user, although a number of registration codes can be provided, each of which will be associated with the user.

The user opens the content-access application on a computer processing device and initiates a registration phase of the content-access application, for example, by clicking a “Registration” button in the open application. The application will then scan to determine available devices having digital storage capability that are accessible to the computer processing device. The target device is selected by the user through the content-access application, such as from a pull-down menu showing all available devices. Any known device having digital storage capability can be made available, such as an internal or external hard drive, SSD drive, portable thumb drive, SSD card, or representational device such as cloud storage.

The target device has an identifier permanently associated with the selected device, of a type that varies based on the type of device. The identifier is a unique, unchangeable value that is characteristic of the selected device, such as a serial number, a container ID, a UDID, an IMEI, a MAC address, and/or a BIOS ID. The content-access application determines the identifier of the selected device and temporarily stores the identifier. The user provides this identifier along with the registration code to the publisher through the content-access application, and the publisher associates the registration code with the identifier to form a registration unit binding the user and the selected device. The publisher stores the registration unit to register the selected device to the user.

The target device can be, for example, a digital storage device of any type, or a computer processing device of any type. If the target device is a computer processing device, it can be the user computer processing device or another computer processing device altogether, such as a computer that is coupled for communication with the user computer processing device. If the target device is a digital storage device, it can be operatively arranged as an internal component of another device (such as an internal hard drive), or operatively coupled to another device as an external component (such as a thumb drive). Preferably, any device having computing and/or storage capability that is configured to communicate with the user computer processing device is available to be the target device, and the content-access application can discover all such devices and make them available to the user as the target device for selection to be registered.

Because a number of publishers could have different content that is of interest to the user, the target device preferably can be registered with more than one publisher so that content from different publishers can be stored on the same device. If necessary or desired, the device volume can be parsed to organize and separate content acquired from different publishers. Of course, if preferred by the user, a different device can be registered with each publisher.

If the selected device is to be replaced, the identifier originally sent to the publisher can be replaced with a new identifier associated with new selected device, by the content-access application through a registration process with the publisher as described above.

Once registration is complete, the user can begin the process of acquiring digital content. To do so, the user requests a content file from the publisher, such as by accessing the publisher's website and selecting the content file at the website. The user confirms identity by providing the registration code to the publisher, either at the website or via another channel. The publisher associates the registration unit associated with the registration code with the requested content file in order to form a unique user content file. For example, the registration unit can be appended to or embedded within the requested content file to form the unique user content file. The publisher can then provide the unique user content file to the user. Typically, this would be done electronically, although if desired the unique user content file can be loaded onto a new registered device by the publisher, and the new registered device can be provided to the user. On receipt, the unique user content file is stored to the registered device by the user, and at the desired file is provided to the content-access application to be presented to the user.

The unique user content file can include still images, animated images, sound files, and/or any combination of media types. Such files can be quite large, and can take a long time to download completely. In the case of large files, or whenever beneficial or desired, downloaded content included in the unique user content file can be streamed while being downloaded to the registered device, such that content is presented to the user even as the rest of the unique user content file is downloading.

In order to access the content on the content file, the user would request access through the content-access application. If multiple content files are stored on the device or devices, the user would select the desired file, such as by making a selection from a pull-down menu or file folder. The content-access application then compares the identifier of the registered device on which the content file is stored with the associated identifier of the selected unique user content file, present in the registration unit associated with the selected unique user content file. If the two identifiers match, or otherwise correspond in a predetermined manner, acquisition and storage were performed properly and access to the unique user content file is granted by and the unique user content file is opened in the content-access application. If the identifiers do not match or otherwise correspond in the predetermined manner, access to the content is denied.

Different types or levels of access to the content file can be requested by and granted to the user. For example, read access, write access, and/or print access can be requested and granted, either as bundled access or separately. Likewise, certain access such as copy access, for example, can be excluded or particularly denied. Further, sections of the document can be redacted based on access permissions. This granularity of access can be enforced through the registration code, which can be coded to define access type or level to be granted to the user for any acquired content. Alternatively, granularity of access can be enforced when forming the unique user content file by adding an access type or level to the registration unit associated with the file, so that access type or level varies for different content files acquired by the same user. Using the same mechanism, access type and level can be changed or otherwise updated through coordination with the publisher.

Overall access and access granularity can also be enforced through the use of encryption. For example, an encryption protocol can be established between the publisher and the content-access application, and the unique user content file can be encrypted before providing the unique user content file to the content-access application. At the user end, the encrypted unique user content file can be decrypted by the content-access application, but only after granting access to the unique user content file to the user by the content-access application. This general scheme can be used to control access, and encryption labels established as part of the protocol can be used to define the type and level of access granted to the user, in general or on a case-by-case basis. Further, access to content files can be limited to online access or can include offline access. Online-only access could be made to restrict access to content only when the user is logged-on, that is, has a communication established with the publisher server, even if the content file is stored locally to the user on a registered device.

Particular exemplary embodiments of the present invention have been described in detail. These exemplary embodiments are illustrative of the inventive concept recited in the appended claims, and are not limiting of the scope or spirit of the invention as contemplated by the inventor.

I claim:

1. A process of registering a device with a publisher, comprising:
providing, to a user, a content-access application;
storing the content-access application for access by a user computer processing device;
providing, to the user by the publisher, a registration code;
opening the content-access application on the user computer processing device;
initiating a registration phase of the content-access application;
selecting, by the user through the content-access application, the device, wherein the device has digital storage capability;
determining, by the content-access application, an identifier permanently associated with the selected device, wherein the identifier is a unique, unchangeable value that is characteristic of the selected device;
temporarily storing the identifier by the content-access application;
providing, by the user to the publisher through the content-access application, the registration code and the identifier;
associating, by the publisher, the registration code with the identifier to form a registration unit; and
storing the registration unit by the publisher, thereby registering the selected device.

2. The process of claim 1, wherein the device is one of a digital storage device, and a computer processing device, wherein the computer processing device is one of the user computer processing device and another computer processing device.

3. The process of claim 2, wherein the digital storage device is one of:
operatively arranged as an internal component of another device; and
operatively coupled to another device as an external component.

4. The process of claim 1, wherein the device is a computer processing device, and the identifier includes at least one of a serial number, a container ID, a UDID, an IMEI, a MAC address and a BIOS ID.

5. The process of claim 1, wherein the selected device is one of a plurality of available devices.

6. The process of claim 1, wherein the registration code is provided to the user by the publisher via email.

7. The process of claim 1, wherein the registration code is provided by the publisher to an email address provided to the publisher by the user.

8. The process of claim 1, wherein the registration code provided to the user by the publisher is one of a plurality of registration codes.

9. The process of claim 1, wherein the publisher is one of a plurality of publishers with which the selected device can be registered.

10. The process of claim 1, wherein the identifier associated with the selected device is a first identifier;
further comprising replacing, by the content-access application through a registration process with the publisher, the first identifier with a second identifier associated with a second selected device;
wherein the second identifier is a characteristic, unique, unchangeable value.

11. The process of claim 10, wherein replacing the first identifier with the second identifier occurs when prompted by the user.

12. A process of acquiring digital content, comprising:
registering a device with a publisher according to the process of claim 1;
requesting, by the user, a content file from the publisher;
providing, by the user, the registration code to the publisher;
associating the registration unit with the requested content file, by the publisher, thereby forming a unique user content file; and
providing the unique user content file to the user for presentation by the content-access application.

13. The process of claim 12, wherein the unique user content file is provided to the user electronically.

14. The process of claim 12, further comprising:
storing the unique user content file to the registered device, by the user; and
providing the unique user content to the content-access application, by the user.

15. The process of claim 12, wherein requesting, by the user, the content file from the publisher includes accessing a publisher's website and selecting the content file at the website.

16. The process of claim 15, wherein the registration code is provided to the publisher at the publisher's website.

17. The process of claim 12, wherein providing the unique user content file to the user includes providing a new registered device to the user, wherein the unique user content file is stored on the new registered device.

18. A process of accessing digital content, comprising:
acquiring the content file according to the process of claim 11;
comparing, by the content-access application, the identifier of the registered device with the associated identifier of the unique user content file; and
granting access to and opening the unique user content file in the content-access application only if the identifier associated with the unique user content file corresponds with the unique identifier stored by the registered device as compared by the content-access application.

19. The process of claim 18, further comprising requesting by the user to the content-access application, access to the unique user content file stored on the registered device.

20. The process of claim 18, wherein granting access to the unique user content file to the user by the content-access application includes granting at least one of read access, write access, and print access.

21. The process of claim 18, wherein granting access to the unique user content file to the user by the content-access application does not include copy access.

22. The process of claim 18, wherein granting access to the unique user content file to the user by the content-access application includes granting offline access to the unique user content file.

23. The process of claim 22, wherein granting access to the unique user content file to the user by the content-access application includes presenting content included in the unique user content file to the user while the unique user content file is downloading.

24. The process of claim 23, wherein the unique user content file includes at least one of still images, animated images, sound files, and any combination of media types.

25. The process of claim 19, further comprising:
enabling an encryption protocol between the publisher and the content-access application;
encrypting the unique user content file before providing the unique user content file to the content-access application; and
decrypting the encrypted unique user content file by the content-access application only after granting access to the unique user content file to the user by the content-access application.
